(19) United States
(12) Patent Application Publication
(10) Pub. No.: US 2022/0292409 A1
(43) Pub. Date: Sep. 15, 2022

(54) RESERVATION ACCEPTING SYSTEM AND RESERVATION ACCEPTING METHOD

(71) Applicant: TOYOTA JIDOSHA KABUSHIKI KAISHA, Toyota-shi (JP)

(72) Inventors: Toshiki KASHIWAKURA, Tokyo (JP); Takahiro SHIGA, Nagakute-shi (JP); Tomoki NISHI, Nagakute-shi (JP); Keisuke OTAKI, Nagakute-shi (JP); Ayano OKOSO, Nagakute-shi (JP)

(73) Assignee: TOYOTA JIDOSHA KABUSHIKI KAISHA, Toyota-shi (JP)

(21) Appl. No.: 17/583,541

(22) Filed: Jan. 25, 2022

(30) Foreign Application Priority Data
Mar. 11, 2021 (JP) 2021-039515

(51) Int. Cl. G06Q 10/02; G06Q 50/30

(52) U.S. Cl. CPC G06Q 10/02; G06Q 50/30

(57) ABSTRACT

A system includes one or more processors configured to: acquire request information including a desired date and time, a point of departure, and a destination, from a user placing a reservation for use of a moving body; derive a reservation result indicating whether the reservation is completed for the request information; derive, based on the request information, the reservation result indicating completion, suspension, or failure for the request information once or a plurality of times; derive, at a first time of deriving the reservation result, one of reservation results including at least the reservation result indicating the completion and the reservation result indicating the suspension for the request information; derive the reservation result indicating the completion or the failure by a predetermined deadline for the request information for which the reservation result indicates the suspension; and notify the user of the reservation result that has been derived.

### CROSS-REFERENCE TO RELATED APPLICATION

This application claims priority to Japanese Patent Application No. 2021-039515 filed on Mar. 11, 2021, incorporated herein by reference in its entirety.

### BACKGROUND

### 1. Technical Field

The disclosure relates to a reservation accepting system and a reservation accepting method.

### 2. Description of Related Art

WO 2019/106745 discloses a demand-responsive transport operating system that operates demand-responsive transport in which vehicles are operated in response to requests by users. This demand-responsive transport operating system receives, from passengers, itinerary requests that include desired departure time and desired arrival time, and point of departure and destination, and create dispatch plans for demand-responsive transport vehicles based on the itinerary requests compiled by a designated time.

### SUMMARY

In the technology disclosed in WO 2019/106745, since vehicle dispatching is planned after itinerary requests of a plurality of users are accepted up to the designated time, the designated time is not reached at a timing when the users request itineraries, so that the users cannot obtain results of the itinerary requests. On the other hand, in a case where vehicle dispatching is planned at a timing when each user places an itinerary request, the itinerary requests accepted later are more likely to be turned down, and the number of completed itinerary requests may be greatly reduced.

The disclosure provides a technology for suppressing decrease in the number of completed requests, while improving ease-of-use for the users.

A reservation accepting system according to a first aspect of the present disclosure includes one or more processors configured to: acquire request information including a desired date and time, a point of departure, and a destination, from a user placing a reservation for use of a moving body; derive a reservation result indicating whether the reservation is completed for the request information; derive, based on the request information, the reservation result indicating completion, suspension, or failure for the request information once or a plurality of times; derive, at a first time of deriving the reservation result, one of reservation results including at least the reservation result indicating the completion and the reservation result indicating the suspension for the request information; derive the reservation result indicating the completion or the failure by a predetermined deadline for the request information for which the reservation result indicates the suspension; and notify the user of the reservation result that has been derived.

A reservation accepting method according to a second aspect of the present disclosure is executed by one or more processors. The reservation accepting method includes: acquiring request information including a desired date and time, a point of departure, and a destination, the request information being requested by a user placing a reservation for use of a moving body; deriving a reservation result indicating whether the reservation is completed for the request information, based on the request information and a derivation function; and notifying the user of the reservation result that has been derived, wherein deriving of the reservation result includes deriving the reservation result indicating completion, suspension, or failure for the request information once or a plurality of times, deriving, at a first time of deriving the reservation result, one of reservation results including at least the reservation result indicating the completion and the reservation result indicating the suspension for the request information, and deriving the reservation result indicating the completion or the failure by a predetermined deadline for the request information for which the reservation result indicates the suspension.

The disclosure can provide a technology for suppressing decrease in the number of completed requests, while improving ease-of-use for the users.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overview of a reservation accepting system according to an embodiment;

FIG. 2 is a diagram illustrating a functional configuration of the reservation accepting system according to the embodiment;

FIG. 3A is a diagram showing request information transmitted from a user terminal device;

FIG. 3B is a diagram showing vehicle information transmitted from a vehicle management device; and

FIG. 4 is a flowchart of notification processing of reservation results by a reservation accepting device.

### DETAILED DESCRIPTION OF EMBODIMENTS

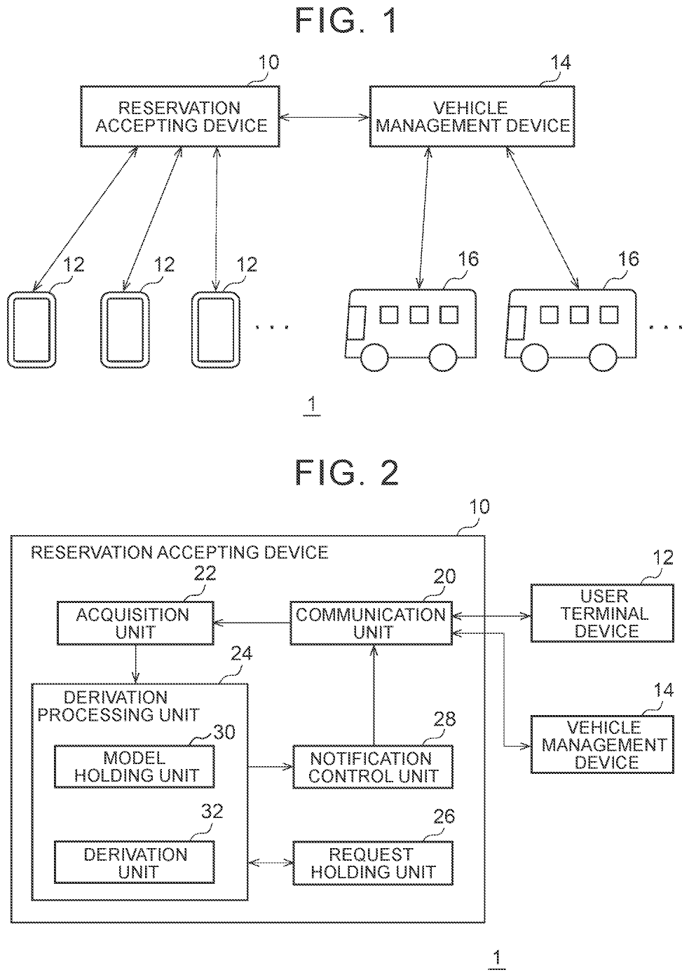

FIG. 1 is a diagram illustrating an overview of a reservation accepting system 1 according to an embodiment. The reservation accepting system 1 includes a reservation accepting device 10, user terminal devices 12, a vehicle management device 14, and vehicles 16. The reservation accepting system 1 accepts reservations for operation by demand-responsive transport from a user. In demand-responsive transport, the reservation accepting device 10 accepts a request from the user to reserve usage of one of the vehicles 16, and operates the vehicle 16 in response to the request to transport the user and a luggage of the user. The vehicle 16 such as a bus illustrated in FIG. 1 enables ride-sharing by the users. Note that although the vehicle 16 is illustrated as a moving body in FIG. 1, the vehicle 16 is not limited to this mode, and may be, for example, a moving body such as a ship or an airplane.

The user terminal device 12 is capable of communication with the reservation accepting device 10. The user uses the user terminal device 12 to request the reservation accepting device 10 to operate the vehicle 16. The user terminal device 12 may be a mobile terminal device that is kept by each user, and holds an application program for requesting operation of the vehicle 16. The user terminal device 12 executes the application program, transmits request information to the reservation accepting device 10, and receives reservation results, from the reservation accepting device 10, indicating that the request has been completed, suspended, or failed.

The request information of the user is accepted until a predetermined acceptance deadline, such as the day before the operating date or the predetermined time before the operating time. In demand-responsive transport, operating in response to request information from all users is desirable, but requests may be failed depending on the contents of the request information of the user, because the number of vehicles 16 that can be operated is limited. Whether requests by users will be completed or failed is ultimately decided by the reservation accepting device 10. The reservation accepting device 10 creates an operating plan corresponding to the completed request, and transmits the operating plan to the vehicle management device 14.

An arrangement in which the reservation accepting device 10 determines whether the request can be completed at a timing when a request from the user is accepted will lead to a first-come-first-served basis system in which requests accepted later are more likely to be rejected, and the number of completed requests is greatly reduced. On the other hand, in an arrangement in which the reservation accepting device 10 suspends all requests from users until the acceptance deadline, and determines whether the requests are completed at the acceptance deadline, the users cannot immediately tell whether the reservation has been completed, which is inconvenient.

The reservation accepting device 10 according to the embodiment can reply with reservation results to the request made by the user in at least two stages, i.e., a timing when the request is accepted, and a timing when the acceptance deadline is reached. For example, immediately after accepting a request from a user, the reservation accepting device 10 notifies the user of reservation results indicating completion, suspension, or failure, with regard to the request, and when the request is suspended, the reservation accepting device 10 notifies the user of the reservation results indicating that completion or failure by a predetermined acceptance deadline. By notifying the reservation results in a plurality of stages as described above, ease-of-use can be improved and the user experience can be improved.

The vehicle management device 14 manages the operation of the vehicle 16. The vehicle management device 14 is capable of communicating with the reservation accepting device 10 and in-vehicle devices of the vehicle 16, accepts vehicle information including position information of the vehicle 16 from the vehicle 16, and transmits the vehicle information to the reservation accepting device 10. Also, the vehicle management device 14 receives an operating plan from the reservation accepting device 10 and manages the vehicle 16 such that the vehicle 16 travels according to the operating plan. The vehicle 16 may be capable of automatic driving.

FIG. 2 is a diagram illustrating a functional configuration of the reservation accepting system 1 according to the embodiment. In FIG. 2, each element described as a functional block that performs various processes can be composed of a circuit block, a memory, and other integrated circuits in terms of hardware, and is realized by programs and so forth loaded to the memory in terms of software. Therefore, it will be understood by those skilled in the art that these functional blocks can be realized in various forms by hardware alone, software alone, or a combination thereof, and are not limited to any particular arrangement.

The reservation accepting device 10 includes a communication unit 20, an acquisition unit 22, a derivation processing unit 24, a request holding unit 26, and a notification control unit 28. The communication unit 20 is capable of communicating with the user terminal device 12 and the vehicle management device 14, and transmits and receives information.

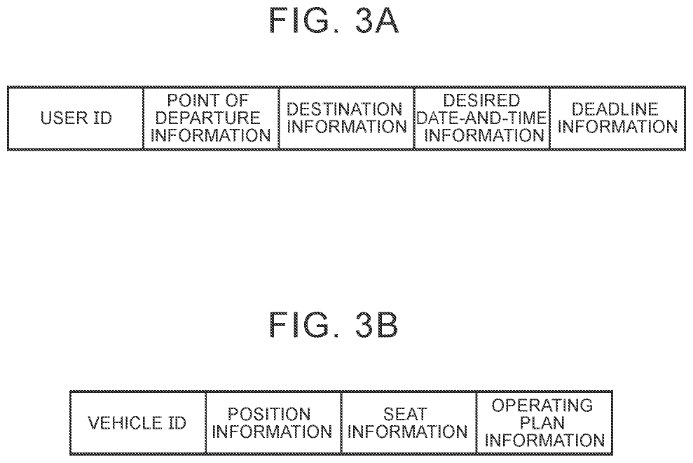

The acquisition unit 22 acquires the request information from the user terminal device 12 and the vehicle information from the vehicle management device 14, via the communication unit 20. The request information and the vehicle information will be described here with reference to FIGS. 3A and 3B.

FIG. 3A shows request information transmitted from the user terminal device 12, and FIG. 3B shows vehicle information transmitted from the vehicle management device 14. As shown in FIG. 3A, the request information includes a user identification (ID), point-of-departure information, destination information, desired date-and-time information, and deadline information.

The point-of-departure information and the destination information may be position information of an embarking/disembarking spot that is set in advance, or may be position information indicated by latitude and longitude. That is to say, the vehicle 16 for demand-responsive transport may move between the embarking/disembarking spots set in advance, or may move to any position desired by the user. The desired date-and-time information may specify any of a departure time, a departure time frame, an arrival time, and an arrival time frame.

The deadline information indicates the deadline for replying to the request desired by the user, and indicates the deadline for receiving reservation results indicating whether the request was completed or failed. The user can receive reservation results indicating whether the request has been completed by the deadline in the deadline information set by the user. Also, when the user does not set a request response deadline, a standard request response deadline will be automatically set. Note that the request information may include the number of passengers, and a single request may be placed to request riding of a plurality of passengers.

As shown in FIG. 3B, the vehicle information includes a vehicle ID, position information, seat information, and operating schedule information. The position information of the vehicle is transmitted from in-vehicle devices of the vehicle 16 to the vehicle management device 14. A seat ID of a seat that can be occupied is held so as to be associated with a user ID of a user that reserved the seat ID in the seat information of the vehicle 16. That is to say, the seat information includes information on reservation of each seat by a user. Thus, the acquisition unit 22 can acquire information regarding the remaining seats for which reservations have not been filled. The operating schedule information is information regarding the operating schedule of the vehicle 16 that has already been decided by the reservation accepting device 10 and so forth.

Description will now return to FIG. 2. The derivation processing unit 24 derives reservation results indicating whether or not a reservation has been completed for the acquired request information. This “or not” includes both suspended and failed statuses. The derivation processing unit 24 includes a model holding unit 30 and a derivation unit 32.

The model holding unit 30 holds derivation function F1 for deriving reservation results, which has been generated based on past request information. Upon receiving input of request information of a certain user, the derivation function F1 outputs the probability of completion of the request information by a score of 0% to 100%, for example.

The derivation function F1 is generated based on past request information, and accordingly outputs that the probability of completion is high as the request information of a certain user is similar to great part of request information completed in the past. The derivation function F1 is a learning model using, for example, decision tree, random forest, logistic regression, support vector machine, k-nearest neighbors algorithm, support vector regression, deep neutral network (DNN), long short-term memory (LSTM), or neural network techniques, and is generated by machine learning using the past request information as teaching data. Thus, empirical determination that has been learned from past request information can be made. Also, the derivation function F1 may be rule-based, and may derive results that the probability of completion is high as there is a large amount of other request information that allows the user to be transported on the same travel route as a travel route included in the request information of a certain user, or may derive results that the request is completed when there is a predetermined amount or more of other request information that allows the user to be transported on the same travel route as a travel route included in the request information of a certain user. Further, the derivation function F1 may be a combination of learning-model and rule-based arrangements. For example, the derivation function F1 may be generated by combining a learning model with a rule that makes it possible to complete the request of users with few reservations are completed.

In learning of the derivation function F1, the object may be to maximize the number of completed requests, but the object is not limited to maximizing the number of completed requests. For example, the object may be to maximize the total riding distance of the user, the usage fee, the profit of the business operator, and so forth, or the object may be a combination thereof.

In order to enable the derivation function F1 to determine the probability of completion based on the weather, the day of the week, and traffic conditions, weather information, day of the week information, traffic information, and so forth, which have been associated with the request information, may be entered in the machine learning of the derivation function F1 as past experience, in addition to the request information.

The derivation function F1 may derive a score indicating the probability of completion with regard to the request information acquired by the acquisition unit 22, and the score may be classified into three categories of completion, suspension, and failure. Alternatively, the derivation function may classify the request information into four categories of completion, high-probability suspension, low-probability suspension, and failure.

In the derivation function F1, the reservation results are derived by inputting not only the request information of a certain user but also the request information of another user and the vehicle information. Using the vehicle information enables the reservation results to be derived based on the number of remaining seats in which the user can be seated. The derivation function F1 may be trained and updated based on accumulated request information and reservation results thereof, at each predetermined interval.

The derivation unit 32 derives the reservation results based on the acquired request information and the derivation function F1. The derivation unit 32 inputs the request information of a certain user into the derivation function F1, and derives that the reservation results will be completed when the score derived by the derivation function F1 is no less than a predetermined threshold value.

It is sufficient for the predetermined threshold value to be set in accordance with the time from the desired date and time of certain request information to the current date and time, and the predetermined threshold value may be set such that the shorter the time is from the desired date and time of the certain request information to the current date and time, the lower the threshold value is, for example. Further, the predetermined threshold value may be set so as to be lower for when the time from the desired date and time of a certain request information to the current date and time is shorter as compared to when the time is longer. For example, the derivation unit 32 may set the predetermined threshold value to 95% at the point of one week before the desired date and time, and set the predetermined threshold value to 70% at the point of two days before the desired date and time. That is to say, the derivation unit 32 derives that the request will be completed when the probability of completion is 95% or higher at the point of one week before the desired date and time, and that the request will be completed when the probability of completion is 70% or higher at the point of two days before the desired date and time. Thus, the predetermined threshold value may be set to be lowered as the desired date and time approaches. Accordingly, the predetermined threshold value can be set such that the request is more likely to be completed as the operating time approaches. Note that the predetermined threshold value may be a fixed value that is set in advance.

Further, the predetermined threshold value may be set based on profile information of the user. For example, the derivation unit 32 may set a predetermined threshold value so as to be lower than a reference value for the request information of a user whose request is frequently failed.

The derivation unit 32 can derive reservation results a plurality of times with regard to the request information acquired by the acquisition unit 22. The derivation unit 32 derives reservation results of suspension or failure when the request information is not completed at a first time, and derives reservation results of completion or failure for the suspended request information from a second time and thereafter, until the predetermined deadline. Also, the derivation unit 32 may derive just reservation results of suspension when the request information is not completed at the first time. That is to say, at least reservation result indicating completion or suspension is derived for the request information at the first time, and reservation results of completion or failure are derived by the predetermined deadline.

Thus, when placing a reservation request, the user can know at least completion or suspension of the reservation at the first time (a timing when the request is accepted), and accordingly reservation results can be recognized at an early stage. Also, the reservation results is determined based on the model generated in accordance with the past request information, and accordingly appropriate reservation results can be derived. On the other hand, the reservation accepting device 10 can temporarily suspend the request information of the user, so that determination can be made after waiting for other request information, and the number of ride-sharing passengers can be increased to increase the number of completed requests.

The derivation unit 32 derives reservation results of completion or failure by the date indicated in the deadline information. Thus, the user can freely set a deadline for indicating completion or failure, and change the suspension state. Accordingly, ease-of-use can be improved for users who wish to know the results early, users who wish ride-sharing in a vehicle even though they have to wait up to the acceptance deadline, and so forth.

When the deadline for accepting requests is reached, the derivation unit 32 derives either completion or failure from the suspended request information, derives the final reservation results, and eliminates the suspended request information. The derivation unit 32 may use the derivation function F1 with an additional rule when the acceptance deadline is reached and the final reservation results are derived. For example, a rule in which, out of the suspended request information, request information having a common point of departure and a common destination is completed with priority, may be added when the final reservation results are derived.

When predetermined reevaluation conditions are satisfied, the derivation unit 32 may derive the reservation results from the suspended request information based on the derivation function F1. That is to say, when the reevaluation conditions are satisfied, the suspended request information is reevaluated, and whether the request information is completed or suspended is determined. The reevaluation conditions include, for example, at least one of conditions that another request has been completed, that the vehicle management device 14 has added operation of a new vehicle, and that the reevaluation time has been reached. When another request is completed, the derivation unit 32 reevaluates whether there is any suspended request information that could enable ride-sharing in the vehicle corresponding to the other request information. Also, when operation of a new vehicle is added, the derivation unit 32 reevaluates whether there is any suspended request information for riding the vehicle. Also, the derivation unit 32 reevaluates the suspended request information at a reevaluation time, such as 1 o'clock PM every day. For example, when the predetermined threshold value becomes lower as the operating time approaches, the probability of completion increases each time the reevaluation time is reached. Thus, the derivation unit 32 derives the reservation results for suspended request information again when the reevaluation conditions are satisfied, even before the acceptance deadline is reached. This enables increasing the probability that the request will be completed before the acceptance deadline.

The request holding unit 26 holds the suspended request information and the completed request information. Accordingly, the derivation unit 32 can re-derive reservation results for the suspended request information. Also, the derivation unit 32 can derive whether the newly acquired request information is such that enables the user to participate in ride-sharing in the vehicle corresponding to the completed request information.

The notification control unit 28 controls notifying the user of the reservation results derived by the derivation unit 32, and transmits the reservation results to the user terminal device 12 via the communication unit 20. The user terminal device 12 outputs the reservation results accepted from the reservation accepting device 10. Also, the notification control unit 28 sends the completed request information to the vehicle management device 14 as an operating plan. The vehicle management device 14 overwrites the completed request information as operating information, and updates the vehicle information.

The derivation unit 32 derives the probability of completing the reservation by the derivation function F1, and the notification control unit 28 sends information indicating the probability of completion to the user terminal device 12 when the reservation results are suspended, and the user terminal device 12 notifies the user of information indicating the probability of completion. The information indicating the probability of completion that is notified to the user by the user terminal device 12 may be a percentage display or a stepwise display. For example, the user terminal device 12 displays the probability of completion in three stages of “high”, “medium”, and “low”, and displays characters, colors, sounds, vibrations, and/or patterns corresponding to each of the three stages. Thus, the user can know the probability of completion when the request information is suspended.

When the request information of the user is suspended, the notification control unit 28 may notify the user of shifting the request information to a time frame in which the probability of completion is high. The time frame in which the probability of completion increases is derived by the derivation unit 32 based on the derivation function F1 generated based on past request information.

The model holding unit 30 may hold a derivation function F2 different from the derivation function F1, and the derivation unit 32 may derive the reservation results using the derivation function F2. The other derivation function F2 derives prediction results for requests predicted to be generated in the future, based on the past request information. The predicted number of requests that will be accepted, for a set date and time, destination, and point of departure, are set in the prediction results of the request. For example, the derivation function F2 is generated by learning based on the number of completed requests and the number of failed requests in the past, the date and time of past requests, environmental information from the past, and so forth. Environmental information includes the weather on the desired date and time of the request, and whether there are large-scale events near the destination and the point of departure, and so forth. As a result, the demand for requests can be predicted, and time frames and routes where requests will be concentrated in the future can be derived.

The derivation unit 32 derives the reservation results of completion or failure based on the prediction results of requests derived by the derivation function F2 and the request information actually acquired. For example, even though a user applies for a request early on, when the derivation unit 32 predicts that requests of another route will be concentrated in the time frame of the request, there is a high probability that the derivation unit 32 will determine that the request is failed. Note that the derivation unit 32 may derive the reservation results for the object of maximizing the number of completed requests, but may derive reservation results for other objects as well, such as maximizing the total traveled distance, for example.

Also, the derivation unit 32 may repeatedly perform the processing of deriving the reservation results of completion or failure based on the prediction results of the requests derived by the derivation function F2 and the request information actually acquired, while changing the parameters of the derivation function F2 a plurality of times to calculate the reservation completion probability, and derive that the request will be completed when the reservation completion probability is no less than a predetermined value. For example, the derivation unit 32 repeats the processing of deriving the reservation results of completion or failure based on prediction results of requests derived by the derivation function F2 and the actually acquired request information ten times, while changing the parameters, and when the request is completed eight times or more out of the ten times, the derivation unit 32 derives that the request will be completed. Also, the derivation unit 32 may determine that the request is to be suspended, depending on the numerical value of the derived reservation completion probability. The derivation unit 32 may derive the reservation results of requests using the derivation function F1 and the derivation function F2. For example, the derivation unit 32 may use the prediction results of requests derived by the derivation function F2 as one of input data to the derivation function F1.

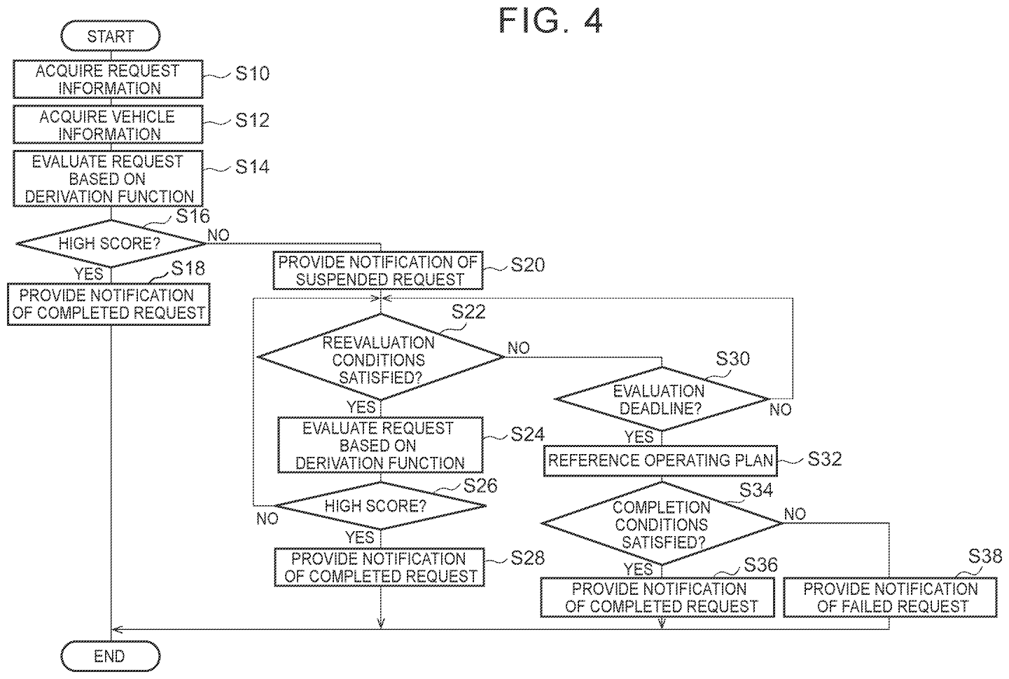

FIG. 4 is a flowchart of notification processing of reservation results by the reservation accepting device 10. The acquisition unit 22 acquires request information from the user terminal device 12 (S10), and acquires vehicle information from the vehicle management device 14 (S12), via the communication unit 20.

The derivation unit 32 inputs the request information and the vehicle information acquired by the acquisition unit 22 to the derivation function F1 to derive a score, and evaluates the request information (S14). When the initial score of the request information derived by the derivation function F1 is a high score that is no lower than a predetermined threshold value (Y in S16), the derivation unit 32 determines that the request is completed, and the notification control unit 28 notifies the user terminal device 12 that transmitted the request information of information indicating that the request has been completed (S18). Thus, notification can be performed regarding completion of the request before the acceptance deadline.

When the initial score of the request information derived by the derivation function F1 is not a high score that is no lower than the predetermined threshold value (N in S16), the derivation unit 32 determines that the request information is suspended, and the notification control unit 28 notifies the user terminal device 12 that transmitted the request information of information indicating that the request has been suspended (S20). The derivation unit 32 determines whether reevaluation conditions are satisfied (S22).

When the reevaluation conditions are satisfied (Y in S22), the derivation unit 32 may derive reservation results from the suspended request information based on the derivation function F1, and perform reevaluation (S24). When the suspended request information that is reevaluated is a high score that is no lower than a predetermined threshold value (Y in S26), the derivation unit 32 determines that the request is completed, and the notification control unit 28 notifies the user terminal device 12 that transmitted the request information of information indicating that the request has been completed (S28). Thus, notification can be performed regarding completion of the request before the acceptance deadline. Note that the predetermined threshold value for determining the score in S26 may be lower than the predetermined threshold value for determining the score in S16. When the reevaluated suspended request information does not have a high score that is no lower than a predetermined threshold value (N in S26), whether the suspended request information satisfies the reevaluation conditions is repeatedly determined until the acceptance deadline is reached (S22).

When the reevaluation conditions are not satisfied (N in S22), the derivation unit 32 determines whether the suspended request information satisfies an evaluation deadline (the acceptance deadline) (S30). The evaluation deadline is a deadline for completing reevaluation and corresponds to the acceptance deadline. When the suspended request information does not satisfy the evaluation deadline (N in S30), determination is repeatedly made regarding whether the reevaluation conditions are satisfied until the acceptance deadline is satisfied (S22).

When the suspended request information satisfies the evaluation deadline (Y in S30), the derivation unit 32 derives final reservation results from the suspended request information and creates an operating plan (S32). Note that after creating the operating plan, the derivation unit 32 may determine that the request of the user who enables ride-sharing in a vehicle according to the operation plan is completed. When the suspended request information satisfies the completion conditions in the final reservation result (Y in S34), the notification control unit 28 notifies the user terminal device 12 that transmitted the request information of information indicating that the request has been completed (S36). The completion conditions are satisfied when the derivation unit 32 determines that the final reservation results are completed.

When the suspended request information does not satisfy the completion conditions in the final reservation results (N in S34), the notification control unit 28 notifies the user terminal device 12 that transmitted the request information of information indicating that the request has been failed (S38). As described above, when the suspended request information reaches the acceptance deadline, a conclusion on whether the request is completed or failed is reached.

It should be noted that the embodiment is only exemplary, and it will be understood by those skilled in the art that various modifications can be made regarding combinations of the components, and that such modifications are also within the scope of the disclosure.

What is claimed is:

1. A reservation accepting system comprising one or more processors configured to:
acquire request information including a desired date and time, a point of departure, and a destination, from a user placing a reservation for use of a moving body;
derive a reservation result indicating whether the reservation is completed for the request information;
derive, based on the request information, the reservation result indicating completion, suspension, or failure for the request information once or a plurality of times;
derive, at a first time of deriving the reservation result, one of reservation results including at least the reservation result indicating the completion and the reservation result indicating the suspension for the request information;
derive the reservation result indicating the completion or the failure by a predetermined deadline for the request information for which the reservation result indicates the suspension; and
notify the user of the reservation result that has been derived.

2. The reservation accepting system according to claim 1, further comprising a storage medium configured to:
hold a derivation function for deriving the reservation result; and
hold the derivation function generated by learning based on past request information.

3. The reservation accepting system according to claim 1, wherein the one or more processors are configured to:
derive information indicating a probability of completing the reservation for the request information; and
notify the user of information indicating the probability of completing the reservation when the reservation result indicates the suspension.

4. The reservation accepting system according to claim 1, wherein:
the request information acquired by the one or more processors includes deadline information; and
the one or more processors are configured to derive the reservation result indicating the completion or the failure by a date indicated in the deadline information.

5. The reservation accepting system according to claim 2, wherein:
the storage medium is configured to hold the derivation function for deriving a score indicating a probability of completing the reservation for the request information based on the request information; and
the one or more processors are configured to
derive the score indicating the probability of completing the reservation for the request information by the derivation function, and
derive that the reservation will be completed when the derived score is no less than a predetermined threshold value; and
the predetermined threshold value is set according to a time from a time at which the request information has been acquired to the desired date and time.

6. The reservation accepting system according to claim 1, wherein the one or more processors are configured to derive again the reservation result for the request information for which the reservation result indicates the suspension, when a predetermined reevaluation condition is satisfied before the predetermined deadline.

7. The reservation accepting system according to claim 1, wherein the one or more processors are configured to:
derive a prediction result of a request that is predicted to occur in a future; and
derive the reservation result indicating the completion or the failure, based on the prediction result for the request that has been derived and the request information.

8. A reservation accepting method executed by one or more processors, the reservation accepting method comprising:
acquiring request information including a desired date and time, a point of departure, and a destination, the request information being requested by a user placing a reservation for use of a moving body;
deriving a reservation result indicating whether the reservation is completed for the request information, based on the request information and a derivation function; and
notifying the user of the reservation result that has been derived, wherein
deriving of the reservation result includes
deriving the reservation result indicating completion, suspension, or failure for the request information once or a plurality of times,
deriving, at a first time of deriving the reservation result, one of reservation results including at least the reservation result indicating the completion and the reservation result indicating the suspension for the request information, and
deriving the reservation result indicating the completion or the failure by a predetermined deadline for the request information for which the reservation result indicates the suspension.
